(19) United States
(12) Patent Application Publication
(10) Pub. No.: US 2015/0349584 A1
(43) Pub. Date: Dec. 3, 2015

(54) BATTERY TO PROVIDE VOLTAGE TO POWER MODULES

(71) Applicant: Hai Ngoc Nguyen, Spring, TX (US)

(72) Inventor: Hai Ngoc Nguyen, Spring, TX (US)

(21) Appl. No.: 14/410,568

(22) PCT Filed: Jun. 27, 2012
(86) PCT No.: PCT/US2012/044430

§ 371 Date: Dec. 22, 2014

(51) Int. Cl. H02J 9/06

(52) U.S. Cl. CPC H02J 9/06

(57) ABSTRACT

Examples disclose a system with a first power module with a first switch to deliver power to a load by connecting the first switch. Further, the examples provide the system with a second power module with a second switch to deliver the power to the load by connecting the second switch, the power to the load from either the first power module or the second power module. Additionally, the examples also disclose a battery to provide voltage to either the first power module or the second power module to enable the delivery of the power to the load by alternating between the first switch in the first module and the second switch in the second power module.

### BACKGROUND

As technology increases, there is a greater dependence on providing reliability within a power system. Utilizing redundant power supplies within the power system increases the reliability by providing another source of power when the input power source fails. This protects computers and systems when an unexpected power disruption occurs potentially causing injuries, data loss and/or business disruption.

### BRIEF DESCRIPTION OF THE DRAWINGS

In the accompanying drawings, like numerals refer to like components or blocks. The following detailed description references the drawings, wherein:

FIG. 1 is a block diagram of an example system including a first power module with a first switch and a second power module with a second switch to deliver power to a load and a battery to provide voltage to either the first power module or the second power module through the first and the second switches;

FIG. 2 is a block diagram of an example system including first generator connected to a first power module with a first switch, a second generator connected to a second power module with a second switch to deliver power to a load with a first and a second power supply, and a battery to provide voltage to either the first power module or the second power module through the first and the second switches;

FIG. 3 is a block diagram of an example power module with a power channel to connect a battery and first switch to provide power to load and a communication channel to deliver a request associated with a second power module to a controller; and

FIG. 4 is a flowchart of an example method performed on a computing device to alternate power between a first switch within a first power module and second switch within a second power module and deliver voltage to a load from either the first power module or the second power module.

### DETAILED DESCRIPTION

Providing redundant power supplies within a power system prepares the system when encountering a power failure. One solution provides a redundant uninterruptible power supply for use in the power system. This solution utilizes two separate uninterruptible power supplies with batteries internal to each power supply. Using the internal batteries, increase the power system size and cost. Additionally, if one of the power supplies experiences failure, it may be difficult to provide near-instantaneous power by the non-faulted power supply as there may be no communication between the power supplies.

In another solution an uninterruptible power supply includes an internal battery and a redundant battery. In this solution, the redundant battery provides back-up to the internal battery to the power supply. However, the redundant battery may be inadequate in the situation the power supply experiences a failure within the internal circuitry. For example, when the power supply experiences a glitch with the circuitry, the redundant battery may provide voltage, however the power supply may continue to experience the failure due to the failure within the internal circuitry. Further, this increases costs and size of the power system as this solution requires two or more batteries. Additionally, both of these solutions are not efficient as it takes more than one battery for the power system to operate.

To address these issues, example embodiments disclosed herein provide a system with a first power module with a first switch and a second power module with a second switch, either of the power modules to deliver power to a load. Additionally, a battery provides voltage to either the first power module through the first switch or the second power module through the second switch. Utilizing the single battery among two power modules increases the power system efficiency while also reducing the size, cost, and weight of the power system.

Additionally, the battery enables one of the power modules to provide power to the load by alternating the switches within each power module. Alternating the switches within each power module enables either module to deliver power to the load. This further increases the efficiency of the power system by enabling a non-faulted power module to deliver the power, preventing any interruptions within the power system.

In another embodiment, the first switch and the second switch are not simultaneously connected. In this embodiment, the connections of the switches are mutually exclusive, enabling the power delivered to the load by either power module. This also increases efficiency as the power is provided by a single power module rather than two power modules delivering power. Delivering power by either power module also prevents the power system experiencing an interruption as either power module may deliver power.

In a further embodiment a communication channel is provided to deliver a request associated with the second power module to the first power module. This allows a faulted power module to communicate with the other power module so the non-faulted power module may connect the corresponding switch to deliver the power.

In summary, example embodiments disclosed herein reduces the cost and space of a power system and increases the efficiency by utilizing a battery between power modules. Additionally, the power system is further increased by preventing power interruptions to a load.

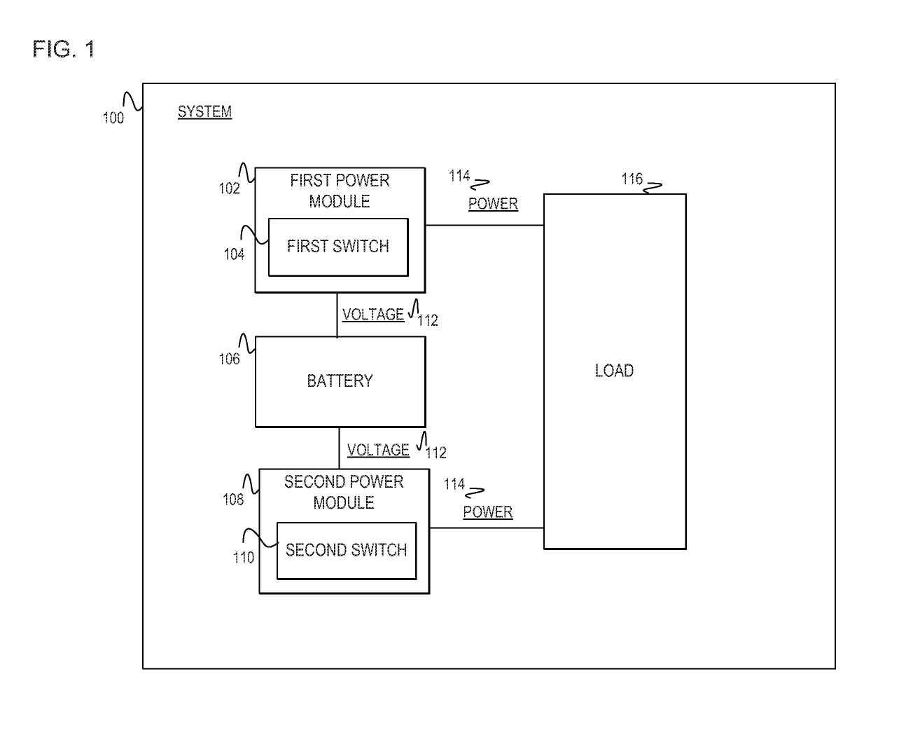

Referring now to the drawings, FIG. 1 is a block diagram of an example system 100 include a first power module 102 with a first switch 104, a second power module 108 with a second switch 110 to deliver power 114 to a load 116. Further, the system 100 includes a battery 106 to provide voltage 112 to either the first power module 102 through the first switch 104 or to the second power module 106 through the second switch 110. Embodiments of the system 100 include a computing device, server, or any other computing system suitable to support the first power module 102, the second power module 108, and the battery 106 to provide voltage 112 to either the first power module 102 or the second power module 108.

The first power module 102 includes the first switch 104 to receive voltage 112 from the battery 106 to transmit power 114 to the load 116. The power modules 102 and 108 are the electrical components to an uninterruptible power supply excluding the battery 106. The power modules 102 and 108 provide power 114 to the load 116 when the main power (i.e., not illustrated) fails. In this embodiment, either the first power module 102 or the second power module 108 provides near instantaneous protection from power interruptions by supplying the power 114 to the load 116. In one embodiment, one of the power modules 102 or 108 may be considered a redundant power module to the other power module 102 or 108. In this embodiment, the redundant power module 102 or 108 operates as a back-up in the situation one of the power modules 102 or 108 fails to provide power 114 to the load 116. In another embodiment, the first power module 102 includes at least one of a converter and an inverter. This embodiment is explained in detail in the next figure. In a further embodiment, the first power module 102 includes a controller to manage the first switch 104 to connect and/or disconnect the battery 106 to the load 116. Yet, in a further embodiment, the first power module 102 and the second power module 108 are each connected to a generator. These embodiments are explained in detail in later figures.

The first switch 104 within the first power module 102 connects to receive voltage 112 from the battery 106 and transmit power 114 to the load 116. The first switch 104 is an electrical device that provides an interruption of the current between between the load 116 and the battery 106. In this embodiment, the first switch 104 provides isolation of the battery 102 to the load 116 through the first power module 102. Embodiments of the first switch 104 include an electromechanical device, mechanical device, a switching voltage regulator, transistor, relay, logic gate, binary state logic, or other type of electrical device that may connect and disconnect the load 116 and the battery 106 through the first power module 102.

The second power module 108 includes the second switch 110 to receive voltage 112 from the battery 106 and transmit power 114 to the load 116. The second power module 108 is separated from the first power module 102 and the battery 106. The second power module 108 may be similar in structure and functionality to the first power module 102.

The second switch 110 within the second power module 108 may receive voltage 112 and transmit power 114 to the load 116. The second switch 110 may be similar in structure to the first switch 104 and as such, embodiments of the second switch 110 include an electromechanical device, mechanical device, a switching voltage regulator, transistor, relay, logic gate, binary state logic, or other type of electrical device that may connect and disconnect the load 116 and the battery 106 through the second power module 108.

The battery 106 uses electro-type cells to convert stored energy to electrical energy to deliver voltage 112 to either the first power module 102 or the second power module 108 depending on which switch 104 and 110 is connected. For example, the battery 106 may deliver voltage 112 to the first power module 102 if the first switch 104 is connected or the battery 106 may deliver voltage 112 to the second power module 108 if the second switch 110 is connected. In one embodiment, the battery 106 and the first power module 102 comprise a first uninterruptible power source and the battery 106 with the second power module 108 comprise a second uninterruptible power source. In this embodiment, utilizing the battery 106 between the first power module 102 and the second power module 108 reduces the size and cost of the system 100 while increasing the efficiency. The battery 106 is typically internal to an uninterruptible power supply, however, in another embodiment, the battery 106 is physically separated from the power modules 102 and 108. This enables two uninterruptible power supplies to utilize the battery 106. Embodiments of the battery 106 include a primary battery (i.e., non-rechargeable battery), a rechargeable battery, or other type of energy storage device suitable to provide voltage 112 to either the first power module 102 or the second power module 108.

The voltage 112 is the electrical potential energy from the battery 106. In one embodiment, the voltage 112 is transmitted from the battery 106 to the first power module 102 on a first power channel and to the second power module 108 on a second power channel.

The power 114 is considered energy provided to the load 116 from either the first power module 102 or the second power module 108. Embodiments of the power 114 include current, voltage, electrical charge, watts, or other type of energy provided to the load 116 from either the first power module 102 or the second power module 108.

The load 116 receives power 114 transmitted by either the first power module 102 or the second power module 108. In one embodiment, the load 116 includes two power supplies as each connected to the power modules 102 and 108. This embodiment is explained in detail in the next figure. Embodiments of the load 116 include an electrical circuit, electrical impedance, or other type of circuit capable of receiving power 114 from either module 102 or 108.

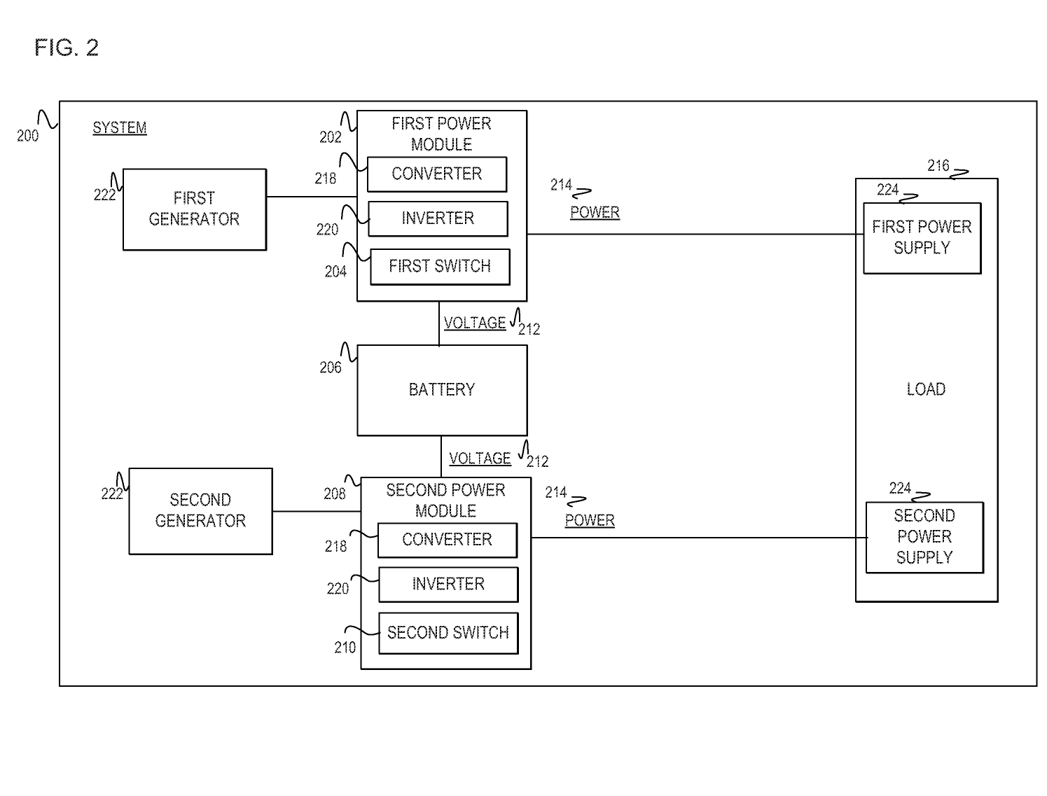

FIG. 2 is a block diagram of an example system 200 including a first generator 222 connected to a first power module 202 with a first switch 204 and a second generator 222 connected to a second power module 208 with a second switch 210. The system 200 also includes a battery 206 to provide voltage 212 to either the first power module 202 or the second power module 208. Either of the power modules 202 or 208 may then deliver power 214 to a load 216 with a first power supply 224 and a second power supply 224. Additionally, the system 200 illustrates the power modules 202 and 208 including at least one of an inverter 220 and a converter 218. The system 200 may be similar in structure and functionality to the system 100 as in FIG. 1.

The first power module 202 may receive voltage 212 from the battery 206 once the first switch 204 is connected. In one embodiment, the first power module 202 may include at least one of the converter 218 and the inverter 220 to convert and/or invert the voltage 212 to transmit the power 214 to the load 216. The first power module 202 with the first switch 204 may be similar in structure and functionality to the first power module 102 and the first switch 104 as in FIG. 1.

The battery 206 may provide the voltage 212 to the first power module 202 through the first switch 204 or the second power module 208 through the second switch 210. The battery 206 and the voltage 212 may be similar in structure and functionality to the battery 106 and the voltage 112 as in FIG. 1.

The second power module 208 may receive voltage 212 from the battery 206 once the second switch 210 is connected. The second power module 208 and the second switch 210 may be similar in structure and functionality to the second power module 108 and the second switch 110 as in FIG. 1.

The converter 218 and/or the inverter 220 may be included in the power modules 202 and 208 to convert and/or invert the voltage 212 from the battery 206 to the power 214 delivered to the load 216. The converter 218 is an electrical device that changes analog voltage to digital voltage and vice versa. The converter 218 may receive the voltage 212 to convert to the inverter 220. The inverter 220 is an electrical device that changes direct current (DC) to alternating current (AC), thus enabling the power 214 to be inverted from voltage 212 to a required voltage and/or frequency as needed by the load 216. In this embodiment, including at least one of the converter 218 and the inverter 220 in the power modules 202 and 208, the voltage 212 received from the battery 206 may be rectified, filtered, modulated, etc. to provide the appropriate power 214 as rated by the load 216. For example, the voltage 212 may include 5V DC, thus the first power module 202 may converter and/or invert this voltage to 12V AC to deliver to the load 216.

The first generator 222 and the second generator 222 are electrical generators that convert fossil fuel (diesel) to electrical energy to provide to the load 216. The generators 222 operate to provide power 214 to the load once the system 200 experiences an interruption. Typically, it may take one of the generators 222 a period of time to provide power 214 to the load 216, thus one of the power modules 202 or 208 with the battery 206 comprise an uninterruptible power supply to provide near-instantaneously power 214 to the load 216 until one of the generators 222 provides the power 214. In one embodiment, one of the power modules 202 or 208 provide power 214 to the load 216 until the corresponding generator 222 provides the electrical energy (i.e., power) to the load 216. In this embodiment, one of the power modules 202 or 208 in combination with the battery 206 comprise an uninterruptible power supply, the other power module 202 or 208 remains disconnected (i.e., receiving no voltage) until the uninterruptible power supply fails to provide the power 214 to the load 216. In another embodiment, the first generator 222 and the second generator 222 are connected to power line from a power source such as power plant (i.e., not illustrated) to transmit power to the load 216. In this embodiment, each power module 202 with the battery 206 comprise a first and a second uninterruptible power supply to provide power 214 to load in case of an interruption of power 214 to the load 216. In this regard, one of the uninterruptible power supplies operate as redundant backup to the power line while the other uninterruptible power supply operates as a redundant backup. Although FIG. 2 depicts the generators 222 as being the same generator, embodiments should not be limited as this was done for clarification purposes. For example, the generators 222 are most likely to be separate generators 222. The first generator 222 may be similar in structure and functionality to the second generator 222, as such embodiments of the generators 222 include an electrical motor, engine-type generator, or other type of electrical generator capable of providing power 214 to the load 216.

The first power supply 224 and the second power supply 224 within the load 216 may receive power 214 to increase, decrease, and/or modulate the power 214 to deliver to the load 216. Although FIG. 2 depicts the power supplies 224 as being the same power supply according to the numbering (i.e., 224), embodiments should not be limited as this was done for clarification purposes. For example, the power supplies 224 may be part of the same power supply 224 or separate power supplies 224. Embodiments of the power supplies 224 include an ac-to dc converter, or other power supply capable of receiving power 214 from either of the power modules 202 or 208.

The load 216 receives power 214 from either the first power module 202 or the second power module 208. The load 216 and the power 214 may be similar in structure and functionality to the load 116 and the power 114 as in FIG. 1.

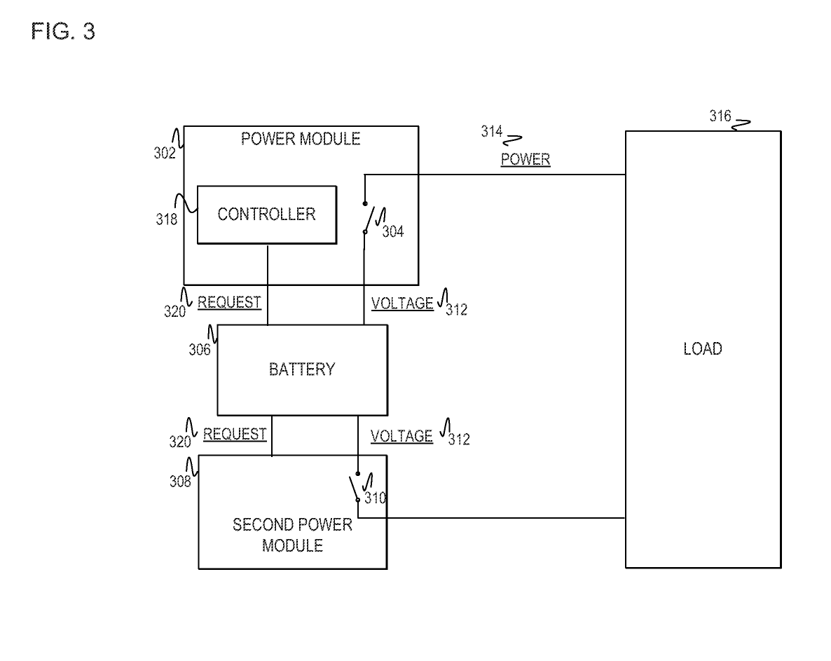

FIG. 3 is a block diagram of an example power module 302 with a power channel to provide voltage 312 from a battery 306 to through either a switch 304 or a second switch 310 within a second power module 308, the power module 302 also delivers power 314 to a load 316. Additionally, the power module 302 includes a controller 318 connected to a communication channel to receive a request 320 associated with the second power module 3208 to manage the switch 304. The power module 302 and the switch 304 may be similar in structure and functionality to the first power module 102 and 202 and the first switch 104 and 204 as in FIGS. 1-2.

The second power module 308 may receive voltage 312 from the battery 306 through the second switch 310. In one embodiment, the switch 304 or the second switch 310 remains connected while the other switch 304 or 310 remains disconnected. In this embodiment, the switch 304 and the second switch 310 are not simultaneously connected nor simultaneously disconnected. Although FIG. 3 depicts the switches 304 and 310 as disconnected, this was done for illustration purposes as the connections of the switches 304 and 310 are mutually exclusive of one another (i.e., not illustrated). For example, once the switch 304 is connected, the second switch 310 is disconnected and vice versa. The second power module 308 and the second switch 310 may be similar in structure and functionality to the second power module 108 and 208 and the second switch 110 and 210 as in FIGS. 1-2.

The battery 306 may provide the voltage 312 on the power channel which connects the battery 302 and the power module 302 as represented with the line next to the voltage 312. In another embodiment, the battery 306 provides voltage 312 to the second power module 308 on a second power channel connected from the battery 306 to the module 308. The battery 306 and the voltage 312 may be similar in structure and functionality to the battery 106 and 206 and the voltage 112 and 212 as in FIGS. 1-2.

The request 320 is associated with the second power module 308 and received by the controller 318 on a communication channel. The request 320 is a communication that may signal the controller 318 to connect or disconnect the switch 304 based on whether the second switch 310 is connected or disconnected. For example, the switch 304 may connect while the second switch 310 remains disconnected, thus the second power module 308 may transmit the request 320 to the battery 306 and/or the power module 302 to disconnect the switch 304 so the second switch 310 may connect. In this embodiment, the switches 304 and 310 are mutually exclusive of each other. Maintaining the mutual exclusivity of the connections of the switches 304 and 310 enables the battery 306 to provide voltage 312 to either the power module 302 or the second power module 308. Further, providing the voltage 312 to either power module 302 and 308 enables one of the power modules 302 or 308 to transmit power 314 to the load 316. In one embodiment, the second power module 308 transmits the request 308 on a second communication channel to the battery 306 and/or the power module 302. Embodiments of the request 320 include a signal, transmission, data, logic, or other type of communication associated with the second power module 308 and received by the controller 318.

The controller 318 receives the request 320 on the communication channel to manage the switch 304 by connecting and/or disconnecting the switch 304. Embodiments of the controller 318 include a processor, circuit logic, a set of instructions executable by a processor, a microchip, chipset, electronic circuit, microprocessor, semiconductor, microcontroller, central processing unit (CPU), or other device capable of controlling the first switch 304 based on the request 320 associated with the second power module 308.

The load 316 may receive the power 314 from either the power module 302 or the second power module 308. In this embodiment, the power modules 302 and 308 will not both provide power 314 simultaneously to the load 316, rather one of the power modules 302 or 308 provide the power 314 to the load 316. The load 316 and the power 314 may be similar in structure and functionality to the load 116 and 216 and the power 114 and 214 as in FIGS. 1-2.

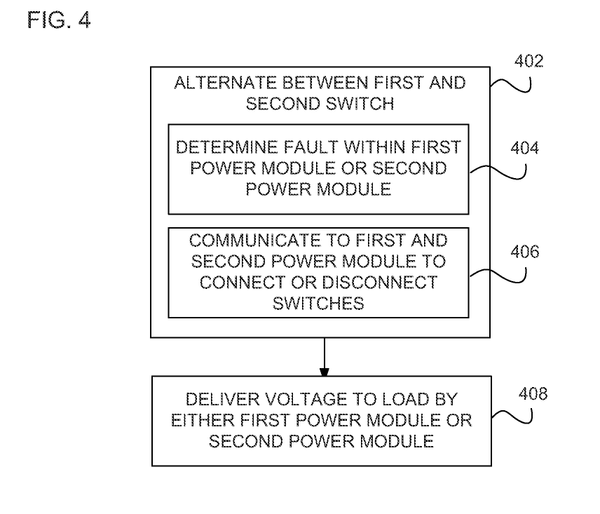

FIG. 4 is a flowchart of an example method performed on a computing device to alternate between a first switch within a first power module and a second switch within a second power module to receive voltage from a battery. Additionally, the method delivers power to a load by either the first power module or the second power module. Although FIG. 4 is described as being performed on a computing device, it may also be executed on other suitable components as will be apparent to those skilled in the art. For example, FIG. 4 may be implemented in the form of executable instructions on a controller, such as 318 as in FIG. 3.

At operation 402 the computing device alternates between the first switch within the first power module and the second switch within the second power module. Alternating between the first switch within the first power module and the second switch within the second power module, enables either the first switch or the second switch to connect while the other switch remains disconnected. In this embodiment, the first switch and the second switch are not simultaneously connected nor simultaneously disconnected. Additionally, alternating between the switches, enables a single battery to be used in conjunction with the power modules to provide voltage to either the first power module or the second power module. For example, the battery may be defaulted to the first power module and providing voltage through the first switch to provide power to the load from the first power module. The battery may be switched to the other power module by connecting the corresponding switch and disconnecting the first switch. In another embodiment, operation 402 includes performing operations 404 and 406.

At operation 404 the computing device determines a fault within the first power module or the second power module to connect and/or disconnect the first switch and the second switch. In this embodiment, the first switch and the second switch may not be simultaneously connect nor simultaneously disconnected. In this regard, the operation of each switch is considered mutually-exclusive to the other switch. In another embodiment, the computing device may detect a fault on a power feed line delivered from a power source to the power module and thus disconnect the corresponding switch and connect the opposite switch to deliver power to the load.

At operation 406 the computing device communicates to the first power module and the second power module to connect or disconnect the first switch and the second switch. In one embodiment, the first power module and the second power module each include a communication channel to request to connect or disconnect the corresponding switch. In this example, either the first power module or the second power module may operate as a master while the other power module operates as a slave. For example, the second power module (i.e., slave) may be disconnected and detect a failure either within the module or on a power line, thus a request may be transmitted to the first power module (i.e., master) to disconnect the first switch so the second switch may be connected to deliver power.

At operation 408 the computing device delivers power to the load by either the first power module through the first switch connection or the second power module through the second switch connection.

In summary, example embodiments disclosed herein reduce the cost and space of a power system and increases the efficiency by utilizing a battery between power modules. Additionally, the power system is further increased by preventing power interruptions to a load.

I claim:

1. A system comprising:
a first power module with a first switch to deliver a power to a load by connecting the first switch;
a second power module with a second switch to deliver the power to the load by connecting the second switch, the power to the load from either the first power module or the second power module; and
a battery to provide voltage to either the first power module or the second power module to enable the delivery of the power to the load by alternating between the first switch in the first power module and the second switch in the second power module.

2. The system of claim 1 wherein the first switch and the second switch are not simultaneously connected.

3. The system of claim 1 further comprising:
a first generator connected to the first power module, the first power module delivers power until the first generator delivers power; and
a second generator connected to the second power module, the second power module delivers power until the second generator delivers power.

4. The system of claim 1 wherein the first power module connected to the battery through the first switch comprises a first uninterruptible power source and the second power module connected to the battery through the second switch comprises a second uninterruptible power source.

5. The system of claim 1 wherein the battery is physically separated from the first power module and the second power module.

6. The system of claim 1 wherein the first power module and the second power module each include at least one of an inverter and a converter.

7. The system of claim 1 wherein the first power module is connected to a first power supply within the load and the second power module is connected to a second power supply within the load.

8. A power module comprising:
a power channel, to connect a battery and a switch, to provide voltage from the battery to the power module; and
a switch to receive voltage from the battery based on a request associated with a second power module, the battery to connect the power module and a second power module and provides voltage to either the power module through the switch or to the second power module through a second switch.

9. The power module of claim 8 further comprising:
a communication channel to transmit the request associated with the second power module to the power module; and
a controller, to connect to the communication channel, to receive the request and to control the switch.

10. The power module of claim 8 wherein the power module and the battery comprise a first uninterruptible power source and the second power module and the battery comprise a second uninterruptible power source.

11. The power module of claim 8 further comprising:
an output channel to deliver power to a load based on receiving voltage from the battery.

12. The power module of claim 8 wherein the first switch and the second switch are not simultaneously connected nor simultaneously disconnected.

13. A method, executed by a computing device, comprising:
alternating between a first switch within a first power module and a second switch within a second power module to provide voltage to either the first power module or the second power module; and
delivering voltage to a load by either the first power module through the first switch connection or the second power module through the second switch connection.

14. The method of claim 13 wherein alternating between the first switch and the second switch is further comprising:
communicating to the first power module and the second power module to connect or disconnect the first switch and the second switch.

15. The method of claim 13 wherein alternating between the first switch within the first module and a second switch within the second module is further comprising:
determining a fault within the first power module or the second power module to connect either the first switch or the second switch.
